(19) United States
(12) Patent Application Publication
(10) Pub. No.: US 2019/0080369 A1
(43) Pub. Date: Mar. 14, 2019

(54) SYSTEMS AND METHODS FOR PROVIDING A DECENTRALIZED PLATFORM FOR CONNECTING MEMBERS OF AN OPEN-SCIENCE COMMUNITY

(71) Applicant: Open Therapeutics, LLC, Cincinnati, OH (US)

(72) Inventors: Martin James Koistinen, Chapel Hill, NC (US); Jason E. Barkeloo, Cincinnati, OH (US)

(21) Appl. No.: 16/122,966

(22) Filed: Sep. 6, 2018

Related U.S. Application Data
(60) Provisional application No. 62/555,989, filed on Sep. 8, 2017.

(51) Int. Cl. G06Q 30/02; H04L 9/06; H04L 9/08

(52) U.S. Cl. CPC G06Q 30/0279; H04L 2209/56; H04L 9/0861; H04L 9/0637

(57) ABSTRACT

Systems and methods of managing research agreements between members in an open-science community are disclosed. A method includes recording a proposal from a researcher in a decentralized ledger, storing funds from a funder in the decentralized ledger, generating a first notification in the decentralized ledger that distributes an indicator to the researcher and the funder that a first portion of the research is to commence, recording deliverables from the researcher to the decentralized ledger, recording votes that indicate whether the deliverables comply with rules established from the proposal in the decentralized ledger, and when a majority of the votes indicates that the deliverables complies with the rules, distributing a tranche of the funds to the researcher and recording the distribution in the decentralized ledger and generating a second notification that distributes an indicator to the researcher and the funder that a second portion of the research is to commence.

### CROSS-REFERENCE TO RELATED APPLICATION

The present application claims priority to U.S. Provisional Patent Application Ser. No. 62/555,989 and entitled “Systems and Methods for Providing a Decentralized Platform for Connecting Members of an Open-Science Community,” the contents of which are incorporated herein in its entirety.

### BACKGROUND

### Field

The present specification generally relates to connecting scientific researchers with funding sources and, more specifically, to systems and methods for providing a decentralized platform that allows scientific researchers and funders to enter into a research agreement.

### Technical Background

Researchers may have a desire to conduct new research and/or collaborate with others, but funding may be difficult to procure and/or potential collaborators may be difficult to find in some instances. For example, a researcher desiring to conduct research on a particular topic may struggle to find collaborators and/or funders with an interest in the same topic or a related topic.

As a result, Internet-based collaboration tools that connect researchers with collaborators and/or funders have emerged. Such Internet-based collaboration tools do not have a system in place that adequately tracks progress once researchers have been matched up with collaborators and/or funders. In addition, such Internet-based collaboration tools do not have a system in place to ensure timely payment of funds. Moreover, existing systems and devices that host data relating to the collaboration (e.g., research data) and the Internet-based collaboration suffer from security flaws, inadequate data backups, inadequate maintenance, an inability to simultaneously share and/or edit data relating to the collaboration, and/or the like.

Accordingly, a need exists for decentralized, Internet-based systems and methods that track progress of researchers, ensure timely payment of funds, and maintain a secure database that can be edited or shared with multiple users at the same time and does not suffer from inadequate backups and/or maintenance.

### BRIEF DESCRIPTION OF THE DRAWINGS

FIG. 1 schematically depicts a plurality of illustrative networked devices that may be used to provide a system for providing a decentralized platform for connecting members of an open-science community according to one or more embodiments shown or described herein;

FIG. 2A schematically depicts a block diagram of illustrative computing device components according to one or more embodiments shown or described herein;

FIG. 2B schematically depicts a block diagram of illustrative logic modules that may be contained within a memory of a computing device according to one or more embodiments shown and described herein;

FIG. 2C schematically depicts a block diagram of illustrative types of data that may be contained within a data storage component of a computing device according to one or more embodiments shown and described herein;

FIG. 3 depicts a flow diagram of an illustrative method of managing research agreements between researchers and a pool of donors in an open-science community according to one or more embodiments shown or described herein; and

FIG. 4 depicts a flow diagram of an illustrative method of managing research agreements between researchers and grantors in an open-science community according to one or more embodiments shown and described herein.

### DETAILED DESCRIPTION

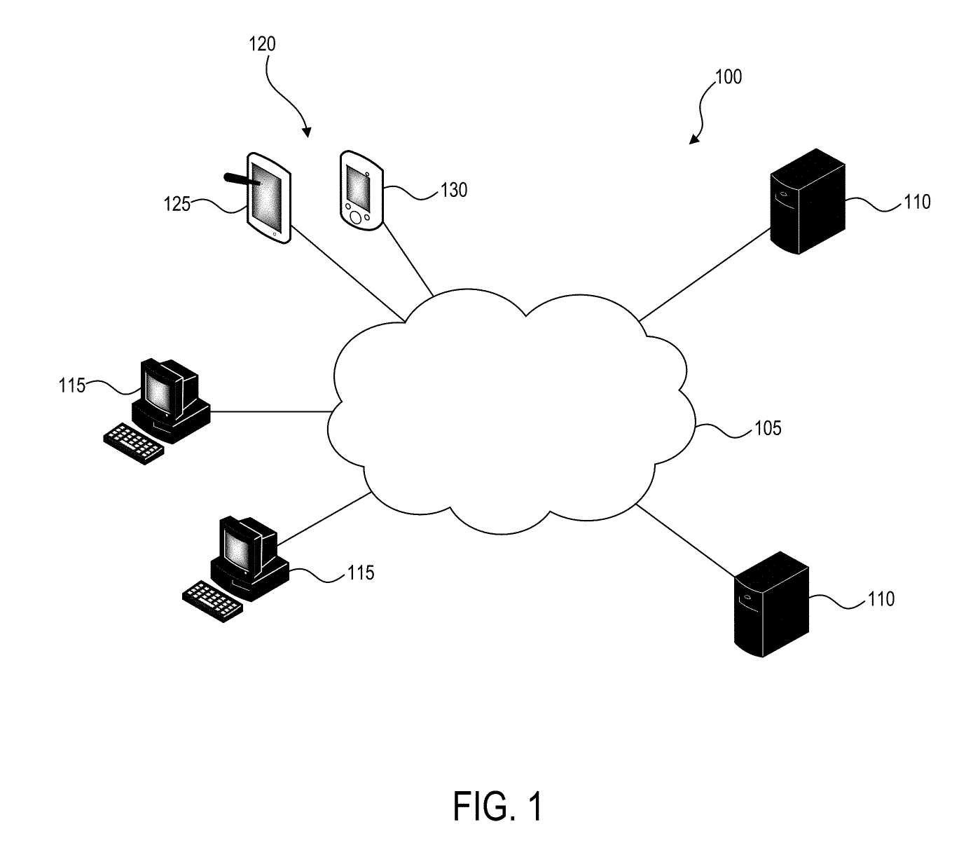

Reference will now be made in detail to embodiments of systems and methods for providing a decentralized platform for connecting members of an open-science community, examples of which are illustrated in the accompanying drawings. Whenever possible, the same reference numerals will be used throughout the drawings to refer to the same or like parts. One embodiment of a system for tracking the positioning of a subject is depicted in FIG. 1, in which the system includes one or more server computing devices, one or more user computing devices, and/or one or more mobile devices that are particularly interconnected to provide the capability described herein. The system in FIG. 1 provides a particularly configured platform that utilizes a blockchain construct to manage connections between members of the open-science community, particularly with respect to connecting researchers with collaborators and/or funders and generating electronic contract documents that are used to track the progress of a research project and provide payment of funds in tranches as a result of completion of particular portions of the research project.

The phrase “communicatively coupled” is used herein to describe the interconnectivity of various components of the system for providing a decentralized platform for connecting members of an open-science community and means that the components are connected either through wires, optical fibers, or wirelessly such that electrical, optical, and/or electromagnetic signals may be exchanged between the components. It should be understood that other means of connecting the various components of the system not specifically described herein are included without departing from the scope of the present disclosure.

As used herein, the phrase “open-science community” generally refers to a community of researchers, funders, educational institutions, nonprofit or for profit corporations, and/or the like that have a common goal to make scientific research, data, and dissemination accessible to all levels of an inquiring society. Members of an open-science community engage in practices such as publishing open research, campaigning for open access, encouraging scientists to practice open notebook science, and generally providing a means of publishing and communicating scientific knowledge such that researchers can build on the works of others to further the knowledge of society in general. In some embodiments, an open-science community may desire to function in a manner that is similar to how open source software functions (e.g., software that is published under the GNU General Public License). That is, scientific research that is conducted by a member of the open-science community with the intent that derivative research and/or research that utilizes concepts from the scientific research is also freely distributed under the same terms. As such, the records that are maintained for prior research need to be accessible to all members of the open-science community to ensure that concepts can be reused and elaborated upon in future research projects.

As used herein, a “blockchain” generally refers to a continuously growing list of records (i.e., blocks) that are linked and secured using cryptography. Each block contains a hash pointer as a link to a previous block, a timestamp, and transaction data. Blocks are inherently resistant to modification of the data. Functionally, a blockchain can serve as an open, decentralized ledger that can record transactions between two parties efficiently and in a verifiable and permanent way. The blockchain may be managed by a peer-to-peer network collectively adhering to protocol for validating new blocks, as described in greater detail herein. Once recorded, the data in a particular block cannot be retroactively altered without an alteration of all subsequent blocks and a collusion of a network majority. As such, the blockchain creates an indelible record of the transactions described herein. In addition, use of the blockchain in the manner described herein improves upon the way data relating to the open-science community and the transactions that are used for funding research is stored and secured, as well as maintaining an integrity of the data, while also allowing members to review information to be used as a basis for further research. As a result, the blockchain creates a resilient, reliable distributed database that can be accessed by any node in the system, as described in greater detail herein.

Centralization of data that is used for the purposes of connecting members of the open-science community may be problematic since this community is built on openness and a centralized location of data can work against this concept of openness if a single entity controls access to the data. As such, a decentralized location of data facilitates the openness necessary for the open-science community. Accordingly, embodiments described herein include a decentralized ledger that documents research efforts of each of the users of an open-science community, documents research data relating to open-science research that is conducted by researchers, documents connections that are made between collaborators or users desiring to collaborate, documents agreements between researchers, collaborators, and/or funders, documents funding tranches, documents progress of research projects, documents voting, documents fund distribution, and/or the like. In some embodiments, the decentralized ledger is stored, modified, and maintained on a plurality of independent nodes and trust is established by rules on the format in the decentralized ledger rather than the source and origin of the information. In such embodiments, the rules are established with cryptographic principles that prevent and/or deter modification of the data. As a result, no centralized location is needed for any transaction completed by members of the open-science community. Rather, members of the open-science community are motivated to verify and confirm past transactions (i.e., verify and confirm completion of a tranche to unlock a next tranche), document and log transactions, and/or solve new challenges (i.e., complete additional research, cast a vote, etc.) to provide the right to register a new creation in the blockchain rights ledger in turn.

A decentralized ledger may also allow researchers, collaborators, funders, and/or the like to increase control of their contribution to the open-science community. This may be accomplished, for example, by removing middlemen or the like and allowing researchers to interact directly with their collaborators and/or funders when conducting a research project.

A decentralized platform for connecting members of the open-science community using a ledger system stored on a plurality of nodes, which is also referred to herein as a computer system, is illustrated in FIG. 1. The computer system, generally designated 100, includes, but is not limited to, a computer network 105 that is generally configured to electronically connect one or more server computing devices 110, one or more user computing devices 115, and/or one or more personal electronic devices 120 (e.g., one or more tablet computing devices 125 and/or one or more mobile devices 130).

The computer network 105 may include any network now known or later developed, including, but not limited to, a wide area network (WAN), such as the Internet, a local area network (LAN), a mobile communications network, a public service telephone network (PSTN), a personal area network (PAN), a metropolitan area network (MAN), a virtual private network (VPN), or any combination thereof.

The one or more server computing devices 110 may receive electronic data and/or the like from one or more sources (e.g., the one or more user computing devices 115), create an initial genesis block in a decentralized ledger, map a decentralized ledger to one or more authentication tokens, mapping references in a decentralized ledger to documents, storing documents referenced in decentralized ledgers, storing metadata relating to documents referenced in decentralized ledgers, communicating with one or more databases, and/or the like. In some embodiments, the one or more server computing devices 110 may function as blockchain management devices. Accordingly, in some embodiments, the one or more server computing devices 110 may control a right or an ability to enter an additional block in the blockchain, as described in greater detail herein.

The decentralized ledger may be transmitted over the computer network 105 to other nodes, including, but not limited to other ones of the one or more server computing devices 110, the one or more user computing devices 115, and/or the one or more personal electronic devices 120. In some embodiments, the computer system 100 is decentralized in a manner such that entire copies of a ledger are stored on multiple nodes. In some embodiments, the ledger may be split up such that portions thereof are stored on different nodes and no single node contains the entire ledger.

The one or more user computing devices 115 may generally provide an interface between a user and the other components connected to the computer network 105, including other users and/or other user computing devices. Thus, the user computing device 115 may be used to perform one or more user-facing functions, such as receiving one or more inputs from a user or providing information to the user. Additionally, in the event that the one or more server computing devices 110 require oversight, updating, or correction, the one or more user computing devices 115 may be configured to provide the desired oversight, updating, and/or correction. The one or more user computing devices 115 may also be used to input additional data into a data storage portion of the one or more server computer devices 110. The one or more user computing devices 115 may also be used as nodes for the purposes of storing and/or updating at least a portion of a blockchain ledger, as described in greater detail herein.

The one or more personal electronic devices 120, including the one or more tablet computing devices 125 and/or the one or more mobile devices 130 are generally electronic devices that provide an interface between a user and the other components connected to the computer network 105, similar to the one or more user computing devices 115. Thus the one or more personal electronic devices 120 may be used to perform one or more user-facing functions, such as receiving one or more user inputs or providing information to a user. The one or more personal electronic devices 120 may also be used to input data into a data storage portion of the one or more server computer devices 110. The one or more personal electronic devices 120 may also be used as nodes for the purposes of storing and/or updating at least a portion of a blockchain ledger, as described in greater detail herein.

It should be understood that while the one or more user computing devices 115 are depicted as personal computers, the server computing devices 110 are depicted as servers, and the one or more personal electronic devices 120 are depicted as tablet computing devices 125 and/or mobile devices 130, these are nonlimiting examples. More specifically, in some embodiments, any type of computing device (e.g., mobile device, tablet computing device, personal computer, server, etc.) may be used for any of these components. Additionally, while each of these computing devices is illustrated in FIG. 1 as a single piece of hardware, this is also merely an example. More specifically, each of the one or more user computing devices 115, the one or more server computing devices 110, and the one or more personal electronic devices 120 125 may represent a plurality of computers, servers, databases, components, and/or the like.

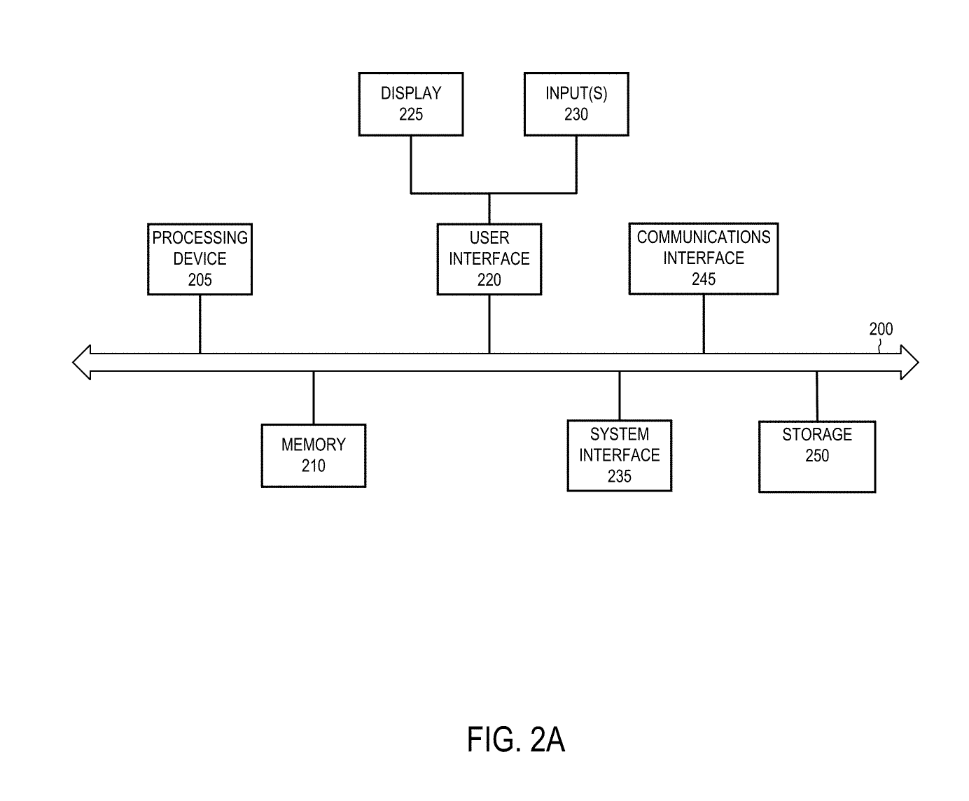

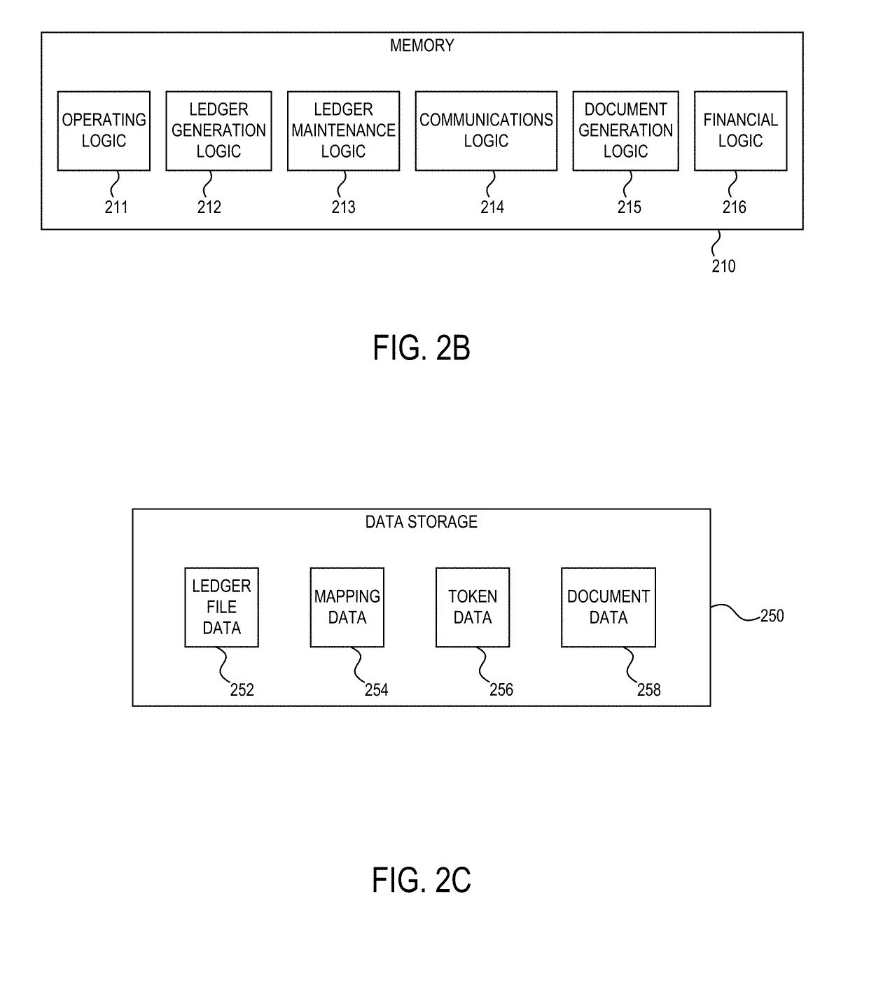

Illustrative hardware components of each one of the one or more server computing devices 110, the one or more user computing devices 115, and/or the one or more personal electronic devices 120 are depicted in FIG. 2A. That is, the hardware components depicted in FIG. 2A may be present in any one of the one or more server computing devices 110, the one or more user computing devices 115, and/or the one or more personal electronic devices 120 depicted in FIG. 1. A bus 200 may interconnect the various components. A processing device 205, such as a computer processing unit (CPU), may be the central processing unit of the computing device, performing calculations and logic operations required to execute a program. The processing device 205, alone or in conjunction with one or more of the other elements disclosed in FIG. 2A, is an illustrative processing device, computing device, processor, or combination thereof, as such terms are used within this disclosure. Memory 210, such as read only memory (ROM) and random access memory (RAM), may constitute illustrative memory devices (i.e., non-transitory processor-readable storage media). Such memory 210 may include one or more programming instructions thereon that, when executed by the processing device 205, cause the processing device 205 to complete various processes, such as the processes described herein. Optionally, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media now known or later developed.

In some embodiments, the program instructions contained on the memory 210 may be embodied as a plurality of software modules, where each module provides programming instructions for completing one or more tasks. For example, as shown in FIG. 2B, the memory 210 may contain one or more of operating logic 211, ledger generation logic 212, ledger maintenance logic 213, communications logic 214, document generation logic 215, and financial logic 216. The operating logic 211 may include an operating system and/or other software for managing components of a computing device or electronic device. The ledger generation logic 212 may include software or the like for generating a decentralized ledger and/or creating a genesis block in a ledger, map the ledger to one or more authentication tokens, map references in a ledger to documents, and/or the like. The ledger maintenance logic 213 may include software or the like for storing a ledger or a portion of a ledger, adding blocks to the ledger as the result of the transactions described herein (i.e., joining collaborators, achievement of a particular task, distribution of funds for a tranche, and/or the like). The communications logic 214 may include software or the like that allows communication with various other nodes for the purposes of transmitting or receiving a ledger, transmitting or receiving a portion of a ledger, transmitting or receiving communications relating to the addition of blocks to the ledger, and/or the like. The document generation logic 215 may include software or the like for generating and/or storing documents referenced in ledgers, storing metadata relating to documents referenced in ledgers, and/or the like. The financial logic 216 may include software or the like for transmitting funds, receiving funds, and/or the like between users, including researchers, funders, financial institutions, clearinghouses, and/or the like. It should be understood that the various logic modules described herein with respect to FIG. 2B are merely illustrative, and that other logic modules, including logic modules that combine the functionality of two or more of the modules described hereinabove, may be used without departing from the scope of the present application.

Referring again to FIG. 2A, a storage device 250, which may generally be a storage medium that is separate from the memory 210, may contain a data repository for storing data that is used for storing electronic data and/or the like relating to an agreement between collaborators, an agreement between one or more researchers and/or one or more funders, and/or data relating to research, including data relating an initial genesis block in a ledger, mapping data between a ledger and one or more authentication tokens, mapping reference data in a ledger to documents, data relating to documents referenced in ledgers, metadata relating to documents, and/or the like. The storage device 250 may be any physical storage medium, including, but not limited to, a hard disk drive (HDD), memory, removable storage, and/or the like. While the storage device 250 is depicted as a local device, it should be understood that the storage device 250 may be a remote storage device, such as, for example, a server computing device or the like.

Illustrative data that may be contained within the storage device 250 is depicted in FIG. 2C. As shown in FIG. 2C, the storage device 250 may include, for example, ledger data 252, mapping data 254, token data 256, and/or document data. Ledger data 252 may include, for example, a ledger, a portion of a ledger, blocks that are added to the ledger, and/or the like. Mapping data 254 may include, for example, data relating to a mapping between a ledger and one or more authentication tokens, data relating to a mapping between a ledger and documents that are referenced in the ledger, data relating to references contained within a ledger, and/or the like, as described in greater detail herein. Token data 256 may include, for example, data relating to authentication tokens that allow for the ledger to be created and/or updated by a particular user, as described in greater detail herein. Document data 258 may include, for example, data relating to documents that are referenced in and/or linked to a ledger, metadata relating to documents, and/or the like.

Referring again to FIG. 2A, an optional user interface 220 may permit information from the bus 201 to be displayed on a display 225 portion of the computing device in audio, visual, graphic, and/or alphanumeric format. Moreover, the user interface 220 may also include one or more inputs 230 that allow for transmission to and receipt of data from input devices such as a keyboard, a mouse, a joystick, a touch screen, a remote control, a pointing device, a video input device, an audio input device, a haptic feedback device, and/or the like. Such a user interface 220 may be used, for example, to allow a user to interact with the computing device, electronic device, or any component thereof.

A system interface 235 may generally provide the device with an ability to interface with one or more of the components of the computer system 100 (FIG. 1). Communication with such components may occur using various communication ports (not shown). An illustrative communication port may be attached to a communications network, such as the Internet, an intranet, a local network, a direct connection, and/or the like. As described in further detail herein, such communication may allow for a decentralized ledger for maintaining agreements among users in an open-science community.

A communications interface 245 may generally provide the computing device with an ability to interface with one or more external components, such as, for example, an external computing device, a remote server, and/or the like that is external to the computer system 100 (FIG. 1). Communication with external devices may occur using various communication ports (not shown). An illustrative communication port may be attached to a communications network, such as the Internet, an intranet, a local network, a direct connection, and/or the like.

It should be understood that in some embodiments, the system interface 235 and the communications interface 245 may be combined into a single device that allows for communications with other devices, regardless of whether such other devices are located within the computer system 100 (FIG. 1).

It should be understood that the components illustrated in FIGS. 2A-2C are merely illustrative and are not intended to limit the scope of this disclosure. More specifically, while the components in FIGS. 2A-2C are illustrated as residing within one or more of the server computing devices 110, one or more of the user computing devices 115, and/or one or more of the personal electronic devices 120, these are nonlimiting examples. In some embodiments, one or more of the components may reside external to one or more of the server computing devices 110, one or more of the user computing devices 115, and/or one or more of the personal electronic devices 120. Similarly, one or more of the components may be embodied in other computing devices not specifically described herein.

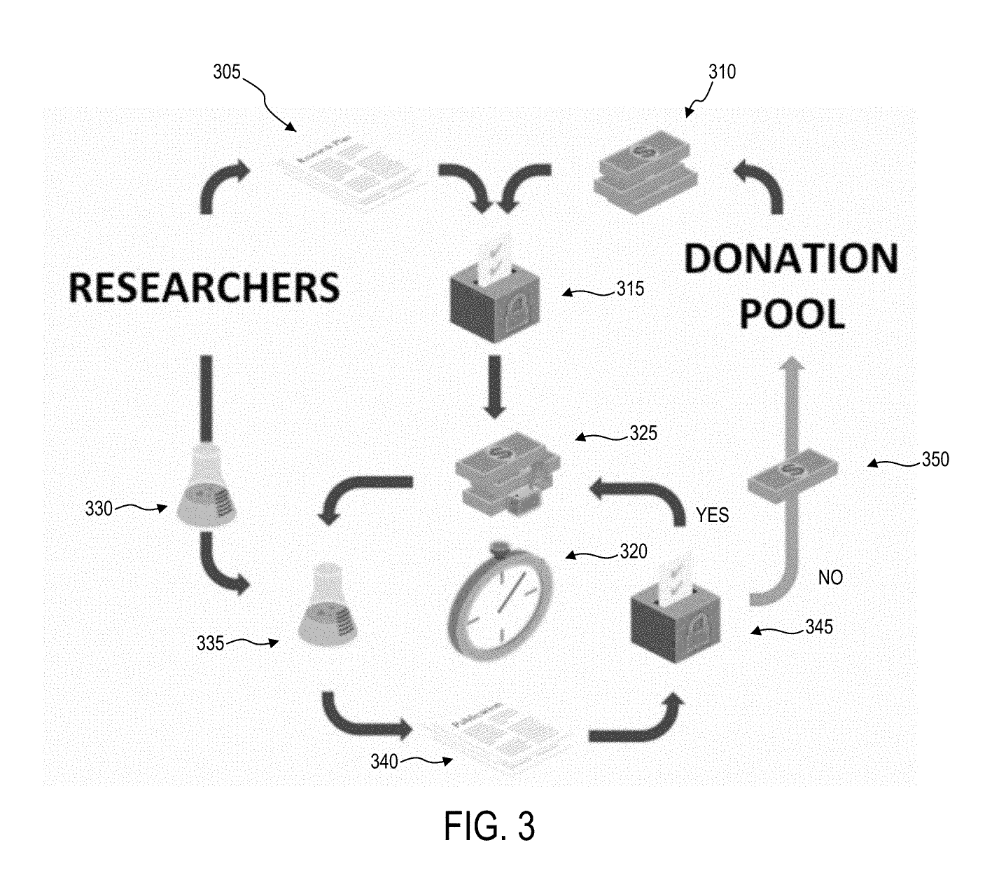

FIG. 3 depicts a flow diagram of an illustrative method of managing research agreements between researchers and a pool of donors in an open-science community according to one or more embodiments. The process described with respect to FIG. 3 generally relates to a single researcher and a pool of donors agreeing to terms for a research project. However, it should be understood that this is merely illustrative, and the process may include any number of researchers and any number of donors in each agreement. Moreover, while the process described with respect to FIG. 3 primarily relates to a single agreement, the process may be completed for a plurality of agreements without departing from the scope of the present disclosure.

As shown in FIG. 3, the process begins at steps 305 and 310. At step 305, a proposal is submitted by a researcher member of the open-science community for a community-based research project. The proposal generally outlines what the project is and outlines how the research will be conducted, how results will be collected, and how the results will be reported. A proposal may have one or more defined tranches. Each tranche may define the cost of the research, which may include, for example, cost of paying personnel, cost of obtaining and/or leasing equipment and supplies, cost of facilities, and/or the like. Each tranche may further define a particular duration thereof. For example, a particular tranche of a research project may last for a particular period of time, such as weeks, months, or years. Each tranche may further define one or more goals and/or outputs that must be completed in order to complete the tranche and unlock the next tranche (if any). Illustrative goals and/or outputs include, for example, achievement of particular research results or findings, publication of a scientific paper, hiring of an employee, purchase of equipment, filing of a patent application, and/or the like.

In some embodiments, step 310 may be completed concurrently or in conjunction with step 305. At step 310, donations from one or more sources, such as a crowdfunded source, are pledged to fund one or more of the community based science projects. That is, a funder may pledge a particular amount of money toward a particular proposal or impending proposal, a particular area of research, a particular researcher, a particular group of researchers, a particular institution, and/or the like, or may make a general donation that can be used to fund any type of research. As such, a funder may specify how he/she would want his/her funds to be used, an amount of funds that are pledged, and/or a timing for which the funds may be supplied. Funders are not limited by this disclosure, and can be any individual or entity, particularly individuals or entities that are associated with the open-science community. Illustrative examples of individuals or entities include, but are not limited to, a single donor, a group or consortium of donors, a fund or trust (e.g., a specifically established fund or a crowdfunded money raising effort), a corporate entity, a research institution, an academic institution, a government entity, and/or the like. The donated funds may be stored as part of a funding block in the decentralized ledger. Storing virtual funds in a blockchain construct should generally be understood and is not described in greater detail herein.

At step 315, a community-based peer-review and voting mechanism may be instituted to review the submitted proposals, decide whether they should be approved, and decide whether an adequate amount of funding exists to fund the proposals based on the donations that are received. As the peer-review is community based, the entire open-science community may be able to review and log a vote as to whether a particular proposal should receive funding, proceed, and/or the like. Users may each have a token or the like that allows them to electronically log their votes, and a vote tally from the electronically logged votes may be entered as a portion of the genesis block of a decentralized ledger, as described in greater detail herein. The votes may be recorded in the decentralized ledger, such as, for example, as a portion of the genesis block in the decentralized ledger.

Once a sufficient amount of funding has been received to start a research project, a new block may be generated within the decentralized ledger (e.g., a notification block), whereupon all of the parties to the research agreement (including researchers, funders, etc.) are notified that the contract has been activated and the clock has been started for the first portion of the scientific research at step 320. That is, a proposal that has been voted as approved may be held pending until a sufficient amount of funding has been donated according to step 310, as described above. Starting the clock means that the researchers have been notified that their proposed research project has been approved and a required amount of funding has been pledged towards the project, and as such, the first portion of the work under the project must be completed to lock or unlock the next tranche in funding at step 325. In some embodiments, the initial start of the clock may coincide with a first tranche of funding. In other embodiments, a researcher may be required to complete one or more initial steps before the first tranche of funding is provided.

At steps 330 and 335, the researcher(s) proceed with performing the required activities in accordance with the approved proposal with the objective of generating a deliverable. The deliverable may be any sort of evidence that is established in the original proposal and recorded as the genesis block in the decentralized ledger. For example, the deliverable may be evidence of a particular amount of research that has been completed.

The deliverable may be submitted at step 340 and is recorded as the next block in the decentralized ledger such that all parties with access to the decentralized ledger are able to see the progress of the research, as well as the original proposal, any agreed terms, potential funding, deliverable requirements. In some embodiments, a single deliverable may be posted. In other embodiments, deliverables may be periodically added to the distributed blockchain ledger as they are reached, even if such deliverables are still within a particular tranche of funding.

While the content of the deliverables may be directly inserted within the blockchain, this may result in a decentralized ledger that is large and unwieldy, which may make the decentralized ledger difficult to distribute among the nodes. As such, in some embodiments, the next block in the ledger may be appended with a specific link to a server or the like where the deliverables are stored such that all of the users of the open-science community may review the deliverables. In some embodiments, the deliverables may be encrypted and accessible only via a token possessed by each of the users of the open-science community. In other embodiments, the deliverables may be encrypted and only accessible by a token held by particular individuals associated with the research project, such as the researchers and the funders. Such an embodiment may particularly be desirable in instances where it may be desirable to keep the specific details of the research project confidential, such as instances where the research relates to military technology, potentially patentable technology, and/or the like, despite originating from an open-science community. In some embodiments, the deliverables may only be accessed via a link encoded within the blockchain ledger. In some embodiments, the deliverables may be encoded with metadata containing a unique code or the like that specifically links the deliverables to the particular block in the ledger so as to ensure that the correct deliverables are appropriately referenced at the particular block in the ledger and further to ensure that the deliverables cannot be altered once they have been linked to the block in the ledger to preserve the integrity of the block. That is, the unique code within the metadata is accessed when the link in the decentralized ledger is accessed, and a verification step is completed to ensure that the unique code matches the same code contained within the decentralized ledger (e.g., within a deliverables block of the decentralized ledger).

It should be understood that the use of the distributed blockchain ledger as described above creates an indelible record that prevents parties from revising the original terms of the research agreement, the original proposal, the original agreed-upon deliverables, the original funding tranches, and/or the like without agreement from all of the parties to update the record, where the agreement itself to update the record would also be recorded as a block in the distributed blockchain ledger.

Upon an ending of a duration of the particular tranche, various members of the open-science community may vote on the progress of the research project at step 345. Voting according to step 345 may generally include, for each voting individual, an evaluation of the deliverables that are associated with the corresponding block on the decentralized ledger, and a determination as to whether the deliverables comply with certain criteria established as part of the proposal before the next tranche can be unlocked. The users that have the ability to vote as to whether the deliverables comply with the criteria may vary. In some embodiments, all users in the open-science community may be permitted to cast a vote. In other embodiments, only a portion of the users in the open-science community may cast a vote, such as, for example, users that contributed funds, users with oversight capabilities, users belonging to a particular group relating to the research project, and/or the like. The votes may be recorded as a block (e.g., a voting block) in the decentralized ledger, either as individual votes or in the aggregate.

Once all of the votes have been cast (or once a particular number of votes have been cast, a particular voting period has elapsed, or the like), the design of the blockchain causes the next tranche to automatically be unlocked, the funds to be released, and causes the clock to start on the next portion of the research if a tally of the votes results in a sufficient number of “yes” votes. If a sufficient number of “yes” votes is not achieved, the blockchain does not unlock the next tranche, as described hereinbelow. The blockchain may be particularly coded such that it unlocks the next tranche based on the percentage of “Yes” votes received. For example, if the researcher receives a simple majority of the votes (e.g., greater than 50% of the votes), the next tranche may be unlocked. In some embodiments, the percentage may be more than just a simple majority, such as, for example, greater than 60% of the votes, greater than 66% of the votes, greater than 75% of the votes, greater than 90% of the votes, greater than 95% of the votes, 100% of the votes, or the like.

If a sufficient number of “yes” votes is received at step 345, the process repeats at step 320 when the next tranche is unlocked. If a sufficient number of “yes” votes is not received, the process may proceed to step 350. At step 350, the decentralized ledger is updated with a new block indicating that the agreement based on the proposal has failed, which causes the remaining funds that were pledged under the agreement to be redistributed for future use. In some embodiments, such funds may be distributed to a donation pool such that they can be used for other research activities. In other embodiments, such funds may be returned to the original donor(s) in an amount that is proportional to what each individual donor initially contributed. In some embodiments, donors may be provided with an ability to select whether they prefer to have their funds redistributed within a donation pool, redistributed toward a particular product, or refunded. The process may return to step 310 in some embodiments such that funds that are redistributed into the donation pool may be used for additional projects. In some embodiments, the process may also return to step 305 where a researcher has an ability to prepare another proposal for approval.

It should be understood that the various steps described herein with respect to FIG. 3 are merely illustrative. Additional or fewer steps may be completed, may be completed in a different order, and/or the like without departing from the scope of the present disclosure.

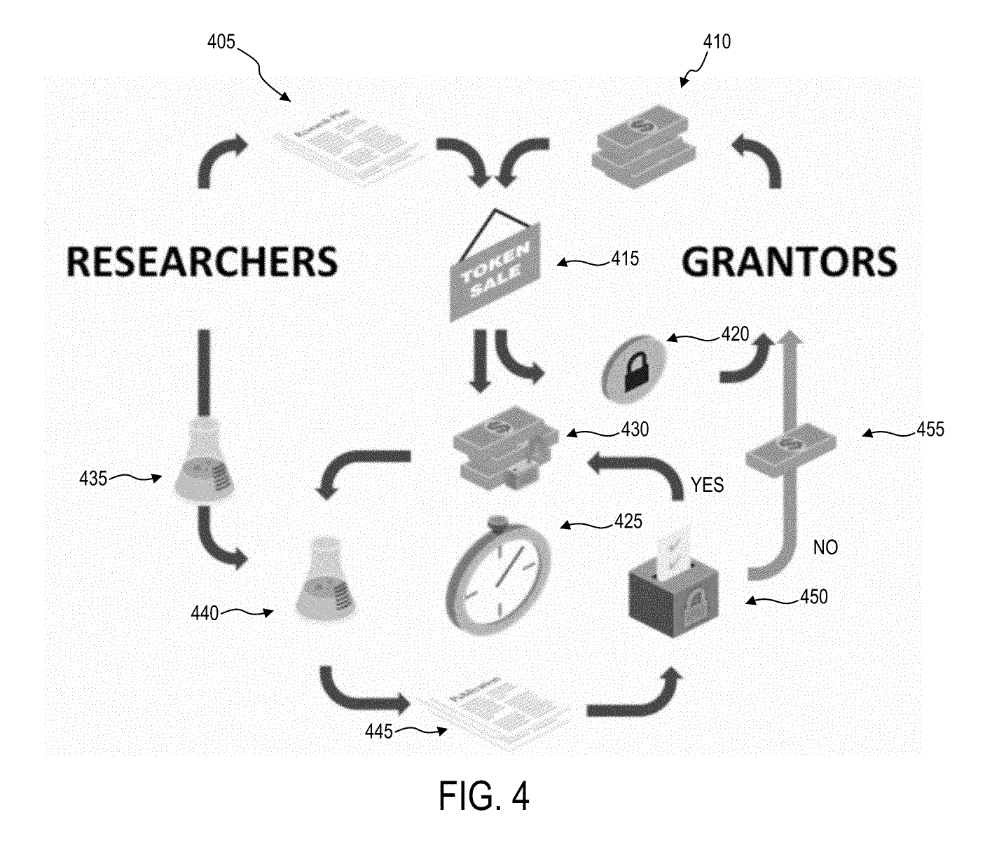

FIG. 4 depicts a flow diagram of an illustrative method of managing research agreements between researchers and grantors in an open-science community according to various embodiments. The embodiment described with respect to FIG. 4 differs from the embodiment described with respect to FIG. 3 in that only grantors have an ability to approve proposals and/or determine whether a research project has adequately completed steps to unlock a tranche in funding. That is, the open-science community as a whole does not have the ability to approve and disprove research proposals and/or vote as to whether a particular set of steps have been adequately satisfied under the research agreement.

The process described with respect to FIG. 4 generally relates to a single researcher and a single grantor agreeing to terms for a research project. However, it should be understood that this is merely illustrative, and the process may include any number of researchers and any number of grantors in each agreement. Moreover, while the process described with respect to FIG. 4 primarily relates to a single agreement, the process may be completed for a plurality of agreements without departing from the scope of the present disclosure.

Step 405 is similar to step 305 as described herein with respect to FIG. 3. That is, at step 405, a proposal is submitted by a researcher member of the open-science community for a community-based research project.

The proposal that is submitted at step 405 is encoded as a portion of the genesis block of a decentralized ledger, as described in greater detail herein. Users of the open-science community, particularly grantors, have an ability to review the genesis block and the information encoded thereon, as well as any information linked to the genesis block, as described in greater detail herein with respect to FIG. 3. If a user decides to fund the research, the user may purchase one or more grant tokens at step 410. The purchase of the one or more grant tokens is recorded as at least a portion of a block in the decentralized ledger. The one or more grant tokens are recorded at step 420 such that they can be used to identify the grantor for the purposes of approving or denying deliverables.

Once a sufficient number of grant tokens have been purchased by one or more grantors at a token sale according to step 415, the ledger may be updated with one or more blocks and the grantors may be notified. The initial tranche of funding is automatically unlocked by the decentralized ledger and distributed to the researcher at step 430. In addition, the countdown clock for completing the first portion of the research is started at step 425.

At steps 435 and 440, the researcher(s) proceed with performing the required activities in accordance with the approved proposal with the objective of generating a deliverable, as described in greater detail herein with respect to steps 330 and 335 in FIG. 3. Still referring to FIG. 4, the deliverable is provided and recorded to the decentralized ledger at step 445. The deliverable may be recorded in a manner that is similar to the method described hereinabove with respect to step 340 in FIG. 3.

At step 450, a voting phase occurs at the time the clock has ended on the portion of the research project. Similar to the process described above with respect to step 345 (FIG. 3), each grantor is able to vote at step 450. In some embodiments, each token purchased by the grantor may be used to cast one vote. As such, grantors who purchased 3 tokens may be entitled to 3 votes. If a sufficient number of “yes” votes that indicate that the deliverables satisfy the agreement have been received, the process may return to steps 425 and 430 to unlock the next tranche so that the researcher can continue the research, until the research is complete. This may further be recorded as at least a portion of the block in the decentralized ledger such that the decentralized ledger can direct that the funds be released for each successive approved tranche.

If a sufficient number of “yes” votes that indicate the deliverables satisfy the agreement have not been received, the result is recorded in the decentralized ledger and the decentralized ledger directs the funds to be returned to the grantors in proportion with what was donated. As such, the process may repeat at steps 405 and 410 as appropriate for new proposals and grants.

It should be understood that the various steps described herein with respect to FIG. 4 are merely illustrative. Additional or fewer steps may be completed, may be completed in a different order, and/or the like without departing from the scope of the present disclosure.

It should now be understood that the systems and methods described herein provide a decentralized platform for connecting members of an open-science community for the purposes of connecting researchers with collaborators and/or funders and generating decentralized electronic contract documents (i.e., in a blockchain construct) that track the progress of a research project and direct the payment of funds in tranches as a result of completion of particular portions of the research project. The systems and methods described herein further improve upon the blockchain construct by adding additional features, flexibility, and capability. More specifically, the systems and methods described herein incorporate research proposals within the blockchain as linked data files that are preserved and encoded with specific links to a particular block in the blockchain so as to preserve the integrity of the blockchain. In addition, the systems and methods described herein utilize the blockchain to unlock tranches of funding only upon a satisfaction of a particular portion of a research project, which is entirely managed by the blockchain construct.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of managing research agreements between a plurality of members in an open-science community, the method comprising:
receiving, by a node in a computer system, a proposal from a researcher;
recording the proposal as a portion of a genesis block in a decentralized ledger, wherein the decentralized ledger is stored in a plurality of nodes in the computer system;
receiving funds from a funder;
storing the funds as a first funding block in the decentralized ledger;
generating a first notification block in the decentralized ledger, wherein the first notification block distributes an indicator to the researcher and the funder that a first portion of the research is to commence;
receiving one or more deliverables from the researcher;
recording the one or more deliverables to a deliverables block in the decentralized ledger;
receiving one or more votes, wherein each of the one or more votes indicates whether the one or more deliverables complies with one or more rules established from the proposal;
recording the one or more votes as a voting block in the decentralized ledger; and
when a majority of the one or more votes indicates that the one or more deliverables complies with the one or more rules:
distributing a tranche of the funds to the researcher and recording the distribution in a second funding block of the decentralized ledger, and
generating a second notification block in the decentralized ledger, wherein the second notification block distributes an indicator to the researcher and the funder that a second portion of the research is to commence.

2. The method of claim 1, further comprising:
prior to generating the first notification block, receiving one or more votes from the plurality of members in the open-science community, wherein the one or more votes from the plurality of members indicate a consensus from the members of the open-science committee that the proposal should receive funding;
recording the one or more votes as a portion of the genesis block in the decentralized ledger; and
designating at least a portion of the funds as being earmarked for a research project corresponding to the proposal.

3. The method of claim 1, wherein the funder is one or more of an individual, a corporate entity, a research institution, a consortium of individuals, a fund, a trust, an academic institution, and a government entity.

4. The method of claim 1, wherein the funds are provided by the funder in exchange for one or more tokens that identify the funder for the purposes of logging a vote within the decentralized ledger.

5. The method of claim 1, wherein the first notification block distributes an indicator to the researcher and the funder that a countdown clock has commenced, the countdown clock indicating an amount of time in which the researcher has to complete the first portion of the research and supply the one or more deliverables.

6. The method of claim 1, wherein recording the one or more deliverables to the deliverables block in the decentralized ledger comprises:
appending one or more files containing the one or more deliverables with metadata containing a unique code;
storing the one or more files containing the one or more deliverables in a central storage device; and
generating the deliverables block to contain the unique code and a link to the one or more files stored in the central storage device such that, when the link is accessed, the unique code within the metadata of the one or more files is accessed and verified that it matches the unique code within the deliverables block.

7. The method of claim 6, wherein storing the one or more files in the central storage device further comprises encrypting the one or more files.

8. The method of claim 7, wherein the one or more files is decryptable only via a token held by one or more of the plurality of members of the open-science community.

9. The method of claim 1, wherein each of the one or more votes is cast by a funder holding a token that provides access to a voting function.

10. The method of claim 1, wherein each of the one or votes is cast by one or more of the plurality of members in the open-science community.

11. The method of claim 1, further comprising:
when a majority of the one or more votes indicates that the one or more deliverables do not comply with the one or more rules:
generating a new block in the decentralized ledger, wherein the new block indicates that an agreement based on the proposal has failed, and
redistributing the funds.
